(19) United States
(12) Patent Application Publication
(10) Pub. No.: US 2025/0367586 A1
(43) Pub. Date: Dec. 4, 2025

(54) HONEYCOMB FILTER

(71) Applicant: NGK INSULATORS, LTD., Nagoya-Shi (JP)

(72) Inventors: Ren KASUGA, Nagoya-Shi (JP); Shiori SHIRAKI, Nagoya-Shi (JP); Tetsuya ITO, Nagoya-Shi (JP)

(73) Assignee: NGK INSULATORS, LTD., Nagoya-Shi (JP)

(21) Appl. No.: 19/304,795

(22) Filed: Aug. 20, 2025

Related U.S. Application Data
(63) Continuation of application No. PCT/JP2024/010931, filed on Mar. 21, 2024.

(30) Foreign Application Priority Data
Mar. 30, 2023 (JP) 2023-055239

(51) Int. Cl. B01D 46/24; B01D 39/20

(52) U.S. Cl. CPC B01D 46/2459; B01D 39/2027; B01D 39/2055

(57) ABSTRACT

A honeycomb filter includes a honeycomb structure having a porous partition wall disposed to surround a plurality of cells and a plugging portion provided to seal either one end of the cells, wherein the cells having the plugging portion at ends on the outflow end face side and open on the inflow end face side are inflow cells, the honeycomb structure further includes a trapping layer for trapping particulate matter in exhaust gas on the inner surface of the partition wall surrounding the inflow cells, the trapping layer is a porous layer in which a plurality of non-oxide particles are bonded via an oxide, a thickness of the oxide that bonds adjacent non-oxide particles is 0.077 μm or more, and when an average particle diameter of the non-oxide particles constituting the trapping layer is R(μm) and a thickness of the oxide is T(μm), a relation of R≤1.0609e\hat{ } (4.7057×T) is satisfied.

### BACKGROUND OF THE INVENTION

### TECHNICAL FIELD

The present invention relates to a honeycomb filter. More particularly, the present invention relates to a honeycomb filter having a trapping layer for trapping particulate matter on a surface of a porous partition wall.

### BACKGROUND ART

In recent years, regulations on removing particulate matter contained in exhaust gas emitted from gasoline engines have become stricter worldwide, and a honeycomb filter having a honeycomb structure has been used as a filter for removing particulate matter. Hereinafter, the particulate matter may be referred to as “PM”. The PM is an abbreviation for “Particulate Matter”.

For example, the honeycomb filter may include a honeycomb filter including a honeycomb structure having a porous partition wall that defines a plurality of cells, and a plugging portion that plugs one end of the cells. Such a honeycomb filter is structured such that the porous partition wall serves as a filter for removing PM. Specifically, after exhaust gas that contains PM is inflowed from an inflow end face of the honeycomb filter and filtered by trapping PM with a porous partition wall, the purified exhaust gas is discharged from an outflow end face of the honeycomb filter. In this way, PM in exhaust gas can be removed.

Conventionally, as a technique for improving trapping performance of a honeycomb filter, techniques for increasing the thickness of a partition wall of a honeycomb structure or reducing the size of pores formed on the partition wall have been proposed. However, when trapping performance is improved by the above-described technique, PM (e.g., soot) is easily clogged in the pore formed on the partition wall, and pressure loss of the honeycomb filter increases. That is, the above-described technique is not an effective solution because the effect of improving trapping performance and the effect of suppressing the increase of pressure loss are in a tradeoff relation.

For this reason, there has been proposed a honeycomb filter in which a trapping layer for trapping PM is provided on a surface of the partition wall of a honeycomb structure (see, for example, Patent Document 1). For example, the trapping layer is composed of a porous membrane having an average pore diameter smaller than the average pore diameter of the partition wall. According to such a honeycomb filter, PM can be deposited on a surface of the trapping layer, so that a sudden increase in pressure loss due to the clogging of PM in pores of the partition wall can be suppressed, and the filtration efficiency when trapping PM can be improved.

### CITATION LIST

### Patent Literature

Patent Document 1: JP-A-2012-206061

### SUMMARY OF INVENTION

### Technical Problem

As described above, in a honeycomb filter in which a trapping layer is provided on the surface of a partition wall, a fine powder is applied to a honeycomb filter precursor, which serves as a base material, to form a membrane, and the dense membrane (i.e., a trapping layer) is formed on the surface of the partition wall. As the membrane forming method, for example, a method of filtering a solution containing a membrane material with a honeycomb filter precursor and a method of drawing an aerosol containing a membrane material into the honeycomb filter precursor are mainly used. As the membrane material, in addition to the same material as the base material, an inorganic compound such as a metal oxide or a metal carbide is used. The process of bonding the membrane material to the base material includes sintering by heat treatment or oxide membrane forming.

Conventionally, in a technique for forming a trapping layer, heat treatment was performed to bond the above-described membrane material, but the conditions to be satisfied in order to withstand various loads after being mounted on an automobile have not been specified. For example, in the above-described Patent Document 1, it is characterized that the melting point of the bonding site of the membrane material is at least equal to or higher than the membrane material, but the structure of the bonding site is not defined. When the honeycomb filter is mounted on an automobile and used, it is subjected to loads of stresses such as vibration and thermal shock in addition to temperature. If the bonding site of the membrane material is formed only to a small extent, even if the bonding site has a high melting point, the structure of the trapping layer may be broken. For example, the trapping layer may be peeled off from the partition wall when subjected to stressful loads such as vibration or thermal shock.

The present invention has been made in view of the problems with the prior arts described above. According to the present invention, it is possible to provide a honeycomb filter in which the trapping layer is hardly peeled off from the partition wall even when stresses such as vibration and thermal shock are applied.

### Means for Solving the Problems

According to the present invention, a honeycomb filter described below is provided.

[1] A honeycomb filter including: a honeycomb structure having a porous partition wall disposed to surround a plurality of cells which serve as fluid through channels extending from an inflow end face to an outflow end face; and
a plugging portion provided to seal either one end on the inflow end face side or the outflow end face side of the cells, wherein
the cells having the plugging portion at ends on the outflow end face side and that are open on the inflow end face side are inflow cells,
the cells having the plugging portion at ends on the inflow end face side and that are open on the outflow end face side are outflow cells,
the honeycomb structure further includes a trapping layer for trapping particulate matter in exhaust gas on the inner surface of the partition wall surrounding the inflow cells,
the trapping layer is a porous layer in which a plurality of non-oxide particles are bonded via an oxide, a thickness of the oxide that bonds adjacent non-oxide particles is 0.077 μm or more, and when an average particle diameter of the non-oxide particles constituting the trapping layer is R(μm) and a thickness of the oxide is T(μm), a relation of R≤1.0609e\hat{ } (4.7057×T) is satisfied.

[2] The honeycomb filter according to [1], wherein the oxide constituting the trapping layer is disposed so as to cover the surface of the non-oxide particles.

[3] The honeycomb filter according to [1] or [2], wherein the non-oxide particles are silicon carbide particles.

### Advantageous Effects of Invention

The honeycomb filter of the present invention is a honeycomb filter having a trapping layer for trapping particulate matter in exhaust gas on the inner surface side of the partition wall surrounding an inflow cell, and has excellent trapping performance. The trapping layer is a porous layer in which a plurality of non-oxide particles are bonded via an oxide, and the thickness of the oxide that bonds adjacent non-oxide particles is 0.077 μm or more. Further, when an average particle diameter of the non-oxide particles constituting the trapping layer is R(μm) and a thickness of the oxide is T(μm), the trapping layer satisfies a relation of R≤1.0609e\hat{ } (4.7057×T). Therefore, in the honeycomb filter of the present invention, the trapping layer is less likely to be damaged even when subjected to stresses such as vibration and thermal shock, and peeling of the trapping layer from the partition wall can be effectively suppressed.

### BRIEF DESCRIPTION OF DRAWINGS

FIG. 1 This is a perspective view schematically showing an embodiment of a honeycomb filter according to the present invention.

FIG. 2 This is a plan view of an inflow end face side of the honeycomb filter shown in FIG. 1.

FIG. 3 This is a plan view of an outflow end face side of the honeycomb filter shown in FIG. 1.

FIG. 4 This is a sectional view schematically showing a section taken along the line A-A′ of FIG. 2.

FIG. 5 This is a sectional view schematically showing a section of the partition wall.

FIG. 6 This is an enlarged sectional view of the trapping layer in the area indicated by the reference numeral P of FIG. 5.

FIG. 7 This is a schematic plan view for explaining a configuration of a vibration testing machine for carrying out a peeling test of the trapping layer.

### DESCRIPTION OF EMBODIMENTS

The following will describe embodiments of the present invention; however, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter

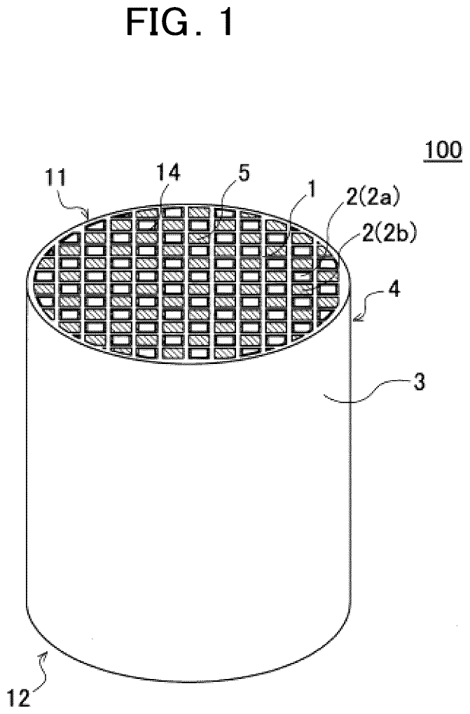

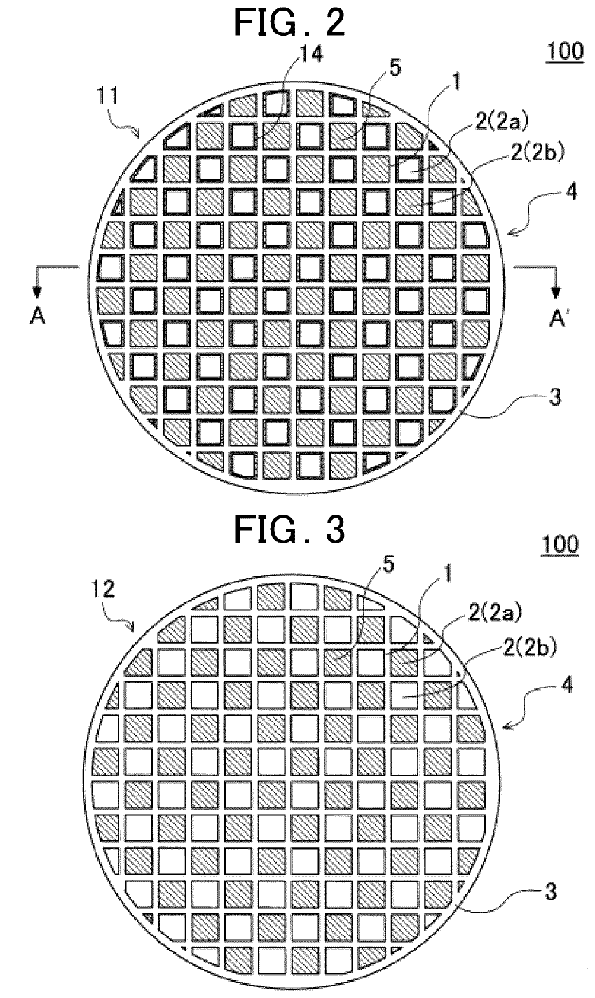

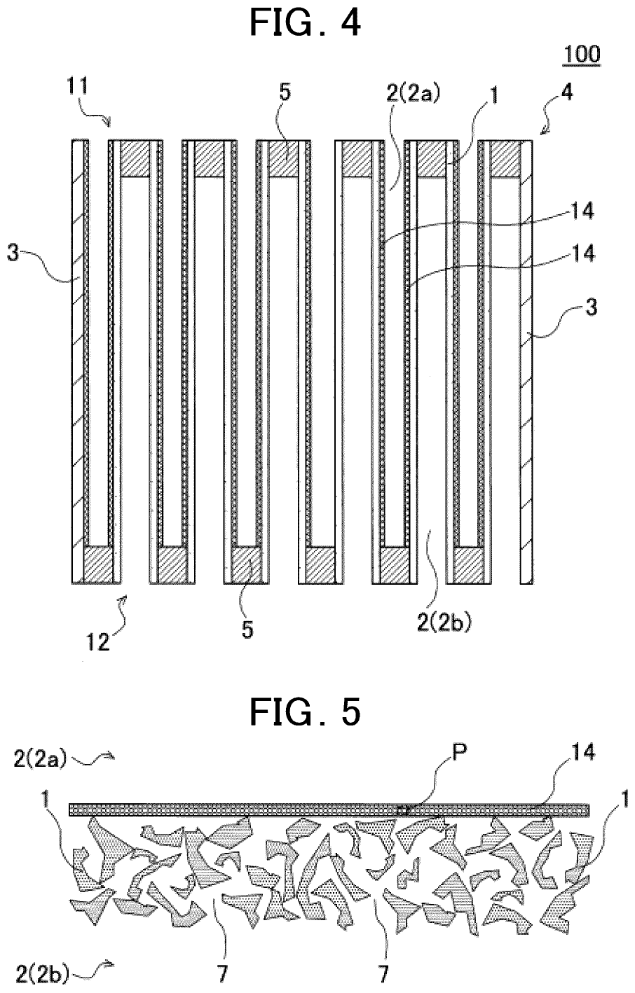

An embodiment of the honeycomb filter of the present invention is a honeycomb filter 100 as shown in FIGS. 1 to 4. Here, FIG. 1 is a perspective view schematically showing an embodiment of a honeycomb filter of the present invention. FIG. 2 is a plan view of an inflow end face side of the honeycomb filter shown in FIG. 1. FIG. 3 is a plan view of an outflow end face of the honeycomb filter shown in FIG. 1. FIG. 4 is a sectional view schematically showing a section taken along the line A-A′ of FIG. 2.

As shown in FIGS. 1 to 4, the honeycomb filter 100 of the present embodiment includes a honeycomb structure 4 and a plugging portion 5. The honeycomb structure 4 includes a porous partition wall 1 disposed to surround a plurality of cells 2 which serve as fluid through channels extending from an inflow end face 11 to an outflow end face 12. The honeycomb structure 4 shown in FIGS. 1 to 4 is formed in a cylindrical shape having an inflow end face 11 and an outflow end face 12 as both end faces, and further has a circumferential wall 3 on an outer peripheral side surface thereof. In other words, the outer circumferential wall 3 is disposed to encompass the partition wall 1 provided in a grid pattern.

The plugging portion 5 is arranged so as to seal either one end on the inflow end face 11 side or the outflow end face 12 side of the cell 2. Hereinafter, among the plurality of cells 2, the cell 2 in which the plugging portion 5 is disposed at an end on the outflow end face 12 side and the inflow end face 11 side is opened is defined as an “inflow cell 2a”. Further, among the plurality of cells 2, the cells 2 in which the plugging portion 5 is disposed at an end on the inflow end face 11 side and the outflow end face 12 side is opened is defined as an “outflow cell 2b”. In the honeycomb filter 100 of the present embodiment, the inflow cell 2a and the outflow cell 2b are preferably arranged alternately with the partition wall 1 therebetween.

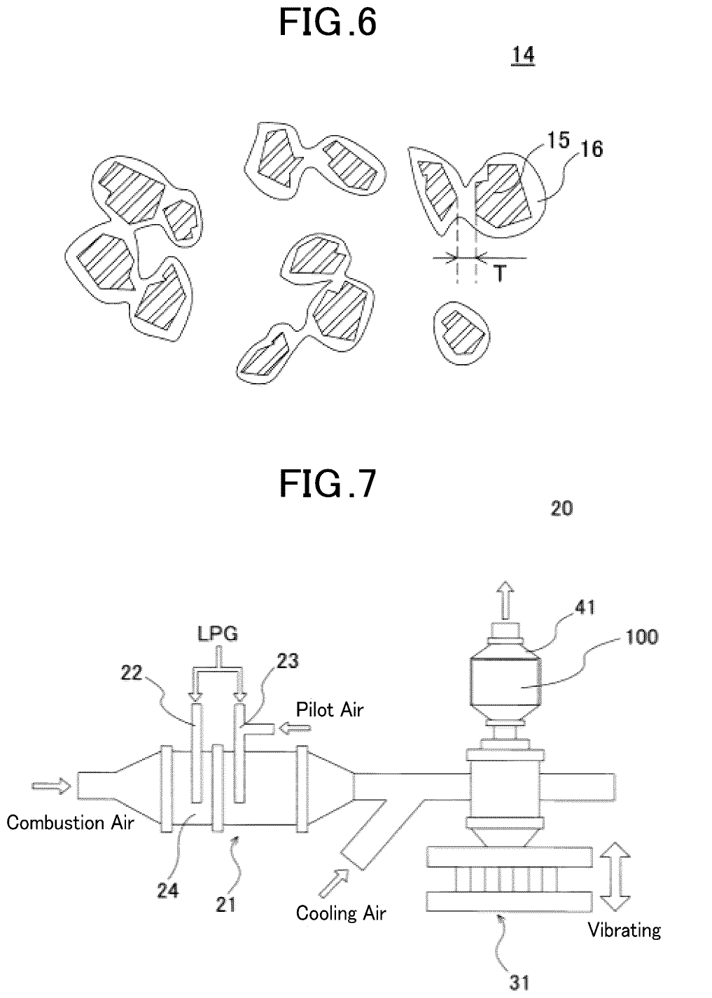

The honeycomb filter 100 is characterized in that the honeycomb structure 4 is configured as follows. That is, as shown in FIGS. 5 and 6, the honeycomb structure 4 further includes a trapping layer 14 for trapping particulate matter (hereinafter, also referred to as “PM”) in exhaust gas on the inner surface side of the partition wall 1 surrounding the inflow cell 2a. The trapping layer 14 is a porous layer in which a plurality of non-oxide particles 15 are bonded via an oxide 16. In the trapping layer 14, the thickness T of the oxide 16 that bonds adjacent non-oxide particles 15 is 0.077 μm or more. Further, an average particle diameter of the non-oxide particles constituting the trapping layer 14 is R(μm) and a thickness of the oxide 16 is T(μm), the trapping layer 14 satisfies a relation of R≤1.0609e\hat{ } (4.7057×T). Hereinafter, the relational expression represented by “R≤1.0609e\hat{ } (4.7057×T)” may be referred to as “the relational expression (1)”. The left side of the relational expression (1) represents the average particle diameter R(μm) of the non-oxide particles. On the other hand, in the right side of the relational expression (1), e represents Napier's constant that is the base of the natural logarithm. The right side of the relational expression (1) is a value obtained by multiplying the Napier's constant (e), which has the exponent “a value obtained by multiplying the thickness T(μm) of the oxide 16 by 4.7057”, by 1.0609. FIG. 5 is a sectional view schematically showing a section of the partition wall. In FIG. 5, the reference numeral 7 denotes a pore formed on the partition wall 1. FIG. 6 is an enlarged sectional view of the trapping layer in the area indicated by the reference numeral P of FIG. 5.

Since the trapping layer 14 is a porous layer composed of the non-oxide particles 15 and the oxide 16 as described above, even if stresses such as vibration and thermal shock are applied, the trapping layer 14 is unlikely to be broken, and separation of the trapping layer 14 from the partition wall 1 can be effectively suppressed. In particular, when the thickness T of the oxide 16 is less than 0.077 μm, the bonding site for bonding the non-oxide particles 15 becomes thin, and the bonding between the non-oxide particles 15 is easily released. Even if the thickness T of the oxide 16 is 0.077 μm or more, in a case where the above relational expression (1) is not satisfied, similarly, the bonding site for bonding the non-oxide particles 15 becomes thin, and the bonding between the non-oxide particles 15 is easily released. For example, when the average particle diameter R(μm) of the non-oxide particles is small, the lower limit value of the thickness Tum of the oxide 16 that is allowed is also small. Then, as the average particle diameter R(μm) of the non-oxide particles increases, the lower limit value of the thickness Tμm of the oxide 16 that is allowed also increases.

The thickness T of the oxide 16 that bonds adjacent non-oxide particles 15 may be 0.077 μm or more, and may be configured to satisfy the relational expression (1) described above. Although not particularly limited, for example, when the average particle diameter R of the non-oxide particles is about 2.2 to 3.0 μm, for example, the thickness of the oxide 16 is preferably 0.155 to 0.230 μm, and more preferably 0.155 to 0.167 μm. For example, when the thickness of the oxide 16 becomes extremely thick, cracks may appear in a layer made of the oxide 16 that bonds the non-oxide particles 15 (hereinafter, also referred to as an “oxide layer”), and the bond (bonding) between the non-oxide particles 15 may be easily broken. For this reason, although not particularly limited, an upper limit value of the thickness of the oxide 16 may be, for example, 0.230 μm.

The average particle diameter R(μm) of the non-oxide particles 15 constituting the trapping layer 14 is not particularly limited. For example, the average particle diameter R(μm) of the non-oxide particles 15 is preferably 0.4 to 2.4 μm, and more preferably 0.9 to 2.4 μm. The average particle diameter R(μm) of the non-oxide particles 15 can be determined by the following method.

First, a part of the partition wall 1 and the trapping layer 14 is cut out as a test piece from a honeycomb structure 4 constituting the honeycomb filter 100 as shown in FIGS. 1 to 3. The position at which the test piece is cut out is between the central section of the honeycomb filter 100 in the extending direction of the cell 2 (i.e., through channel direction) and the outflow end face 12 (excluding the portion on the outflow end face 12 side where the plugging portion 5 is disposed).

Next, the cut test piece is cut in a direction orthogonal to the extending direction of the cells 2, and the cut surface is polished. The cut surface is polished by mechanical polishing.

Next, the polished cut surface is imaged using a scanning electron microscope (hereinafter, also referred to as “SEM”) to obtain SEM images. “SEM” is an abbreviation for “Scanning Electron Microscope.” The imaging conditions are as follows: magnification: 200 times; file format: TIF, width: 1280 pixel, height: 960 pixel. SEM images are captured for four fields of view. The imaging of the four fields of view may be performed, for example, at four different points of one test piece, or four test pieces may be prepared and performed on each test piece. SEM images of four fields of view are hereinafter also referred to as “four levels”.

Next, among the non-oxide particles 15 constituting the trapping layer 14 shown in the SEM images, only the non-oxide particles 15 present on the partition wall 1 which is a base material are binarized. That is, the non-oxide particles 15 present inside the pores of the partition wall 1 and the non-oxide particles 15 present across the part where the partition wall 1 is present are not subjected to binarization analysis. For example, when the partition wall 1 shown in the SEM image is positioned at the bottom of the image, a line segment is virtually drawn on the boundary corresponding to the surface of the partition wall 1, and only the non-oxide particles 15 existing above the line segment are subjected to binarization analysis. Thus, a more accurate average particle diameter R(μm) of the non-oxide particles 15 can be calculated. The binarization process is performed using image-analysis software “Winroof 2018 (Mitani corporation) (trade name)” manufactured by Mitani Corporation. For the binarization analysis item, “equivalent circle diameter” is selected, and the average particle diameter R(μm) of the non-oxide particles 15 is calculated.

The thickness T(μm) of the oxide 16 constituting the trapping layer 14 can be measured as follows. First, a part of the partition wall 1 and the trapping layer 14 is cut out as a test piece from a honeycomb structure 4 constituting the honeycomb filter 100 as shown in FIGS. 1 to 3. The position at which the test piece is cut out is between the central section of the honeycomb filter 100 in the extending direction of the cells 2 (i.e., through channel direction) and the outflow end face 12 (excluding the portion on the outflow end face 12 side where the plugging portion 5 is disposed).

Next, the cut test piece is cut in a direction orthogonal to the extending direction of the cells 2, and the cut surface is polished. In the polishing of the cut surface, after mechanical polishing is performed, ion polishing is performed.

Next, the polished cut surface is imaged using a field emission scanning electron microscope (hereinafter, also referred to as “FE-SEM”) to obtain SEM images of a magnification of 6000 times. “FE-SEM” is an abbreviation for “Field Emission Scanning Electron Microscope.” The imaging condition is as follows: acceleration voltage: 1.5 kV. SEM images are captured for four fields of view. The imaging of the four fields of view may be performed, for example, at four different points of one test piece, or four test pieces may be prepared and performed on each test piece. SEM images of four fields of view are hereinafter also referred to as “four levels”.

Next, the constituent components of the trapping layer 14 shown in the SEM image are subjected to qualitative analysis by EDS analysis, and whether the constituent components are an oxide or a non-oxide is confirmed.

Next, image analyses are performed on the trapping layer 14 in the obtained SEM images. In the image analysis, among the particles constituting the trapping layer 14 in the SEM image, the top three particles (non-oxide particles 15) in terms of the largest sectional area are used as the particles to be measured. Then, the thickness Tₙ of the oxide 16 that bonds the non-oxide particles 15 is measured at five points on the outer periphery of the particles to be measured. The five measurement points of the outer periphery of the particles to be measured are determined so as to be equal to the outer peripheral length. Further, the boundary between the surface of the non-oxide particles 15 and the oxide 16 is specified by being shown in white in the vicinity of the outer peripheral portion of the particles to be measured in the SEM images. A method of measuring the thickness is to measure the distance between two points between the outer periphery of the particles to be measured and the boundary. The image analysis is performed using “Image J (product name)” of the National Institutes of Health (NIH). It is presumed that the phenomenon in which the boundary between the surface of the non-oxide particles 15 and the oxide 16 is shown in white is caused by the influence of charge-up (charging phenomenon) by an electron beam. That is, the SEM image used for image analysis is a secondary electron image, and is affected by charge-up (charging phenomena) by the electron beam. Charge-up refers to a phenomenon in which, when a sample containing an insulator is measured, the insulator is charged and an appropriate result cannot be obtained. Since the non-oxide particles 15 and the oxide 16 are lightly insulated and charged due to the difference in conductivity between them, they are shown in white by charge-up. Since the conductivity of the non-oxide particles 15 and the conductivity of the oxide 16 are basically different from each other, it is possible to discriminate the boundary by the shading of the image.

In each level of image analysis, the thickness Tₙ of the oxide 16 is measured at each of the seven points of the three particles to be measured. Of the seven measured points, the five points excluding the maximum value and the minimum value are taken as the measured values for the above-described three particles to be measured. Then, an average value for a total of 15 points of the five points is calculated. Then, the respective average values of the four levels are further averaged to calculate the thickness T of the oxide 16 as the final measured value. Therefore, the thickness T(μm) of the oxide 16 as the final measured value is the average value of the thickness Tₙ of the oxide 16 for a total of 60 points.

The oxide 16 constituting the trapping layer 14 constitutes a bonding site responsible for bonding the non-oxide particles 15. The oxide 16 may be any oxide that bonds the non-oxide particles 15 that are aggregates in the trapping layer 14. However, the oxide 16 is preferably disposed so as to cover the surface of the non-oxide particles 15. With such a configuration, the bonding between the non-oxide particles 15 can be made stronger, the trapping layer 14 is less likely to be destroyed, and the peeling of the trapping layer 14 from the partition wall 1 can be suppressed highly effectively.

The type of the oxide 16 that bonds the non-oxide particles 15 is not particularly limited, but is preferably an oxide having a melting point of 1200° C. or higher, and examples thereof include silicon oxide, cerium oxide, titanium oxide, and zirconium oxide. In the honeycomb filter 100 of the present embodiment, the oxide 16 is preferably silicon oxide.

The particles constituting the trapping layer 14 may be particles made of non-oxide (non-oxide particles 15). Examples of the components constituting the non-oxide particles 15 include silicon carbide, cerium, titanium, and zirconium. In the honeycomb filter 100 of the present embodiment, the non-oxide particles 15 are preferably silicon carbide particles. By using silicon carbide particles as the non-oxide particles 15, the non-oxide particles 15 are sintered to each other, and then the sintered non-oxide particles 15 are heat-treated under a predetermined condition in an oxidizing atmosphere, whereby the oxide 16 serving as a bonding site can be easily formed between the non-oxide particles 15. That is, the sintered part of the non-oxide particles 15 is oxidized to become silicon oxide (SiO₂), and the trapping layer 14 made of a porous layer in which a plurality of non-oxide particles 15 are bonded via an oxide 16 can be easily manufactured. As for cerium, titanium, and zirconium other than silicon carbide, the sintered part of the non-oxide particles 15 is also oxidized to become an oxide of each component.

The trapping layer 14 is preferably disposed only on the inner surface of the partition wall 1 surrounding an inflow cell 2a. When the trapping layer 14 is disposed outside the inner surface of the partition wall 1 surrounding the inflow cell 2a, pressure loss of the honeycomb filter 100 may be increased.

The average pore diameter of the trapping layer 14 is preferably smaller than the average pore diameter of the partition wall 1. With such a configuration, the trapping layer 14 disposed on the inner surface side of the partition wall 1 surrounding the inflow cell 2a can favorably trap PM contained in exhaust gas.

The average pore diameter of the trapping layer 14 is preferably 2 to 9 μm, more preferably 2 to 7 μm, and particularly preferably 3 to 5 μm. The average particle diameter R(μm) of the non-oxide particles 15 constituting the trapping layer 14 is not particularly limited. For example, the average particle diameter R(μm) of the non-oxide particles 15 is preferably 2.4 μm or less. By setting the average particle diameter R(μm) of the non-oxide particles 15 to 2.4 μm or less, the bonding between the non-oxide particles 15 can be made stronger, the trapping layer 14 is less likely to be broken, and the peeling of the trapping layer 14 from the partition wall 1 can be suppressed highly effectively.

The porosity of the trapping layer 14 is preferably 55 to 90%, more preferably 55 to 858, and particularly preferably 60 to 85%. If the porosity of the trapping layer 14 is less than 55%, pressure loss may increase. On the other hand, if the porosity of the trapping layer 14 is greater than 90%, filtration efficiency may deteriorate.

The porosity and average pore diameter of the trapping layer 14 can be measured in the following manner. First, the sectional area of the trapping layer 14 is observed by a scanning electron microscope to obtain SEM images thereof. The SEM images are observed at a magnification of 200 times. The acquired SEM images are then image-analyzed to binarize the entity portion of the trapping layer 14 and the void portion in the trapping layer 14. Then, a percentage of a ratio of the void portion in the trapping layer 14 to a total area of the entity portion and the void portion of the trapping layer 14 is calculated, and the value is defined as a porosity of the trapping layer 14. In addition, the gaps between the respective particle diameters in the SEM images are binarized, and the size thereof is directly measured on a scale, and the pore diameter in the trapping layer 14 is calculated from the measured value. The calculated average pore diameter is defined as the average pore diameter of the trapping layer 14.

The thickness of the trapping layer 14 is preferably 10 to 60 μm, more preferably 20 to 50 μm, and particularly preferably 20 to 40 μm. If the thickness of the trapping layer 14 is less than 10 μm, it is not preferable because improvement in filtration efficiency may be reduced. On the other hand, if the thickness of the trapping layer 14 is greater than 60 μm, it is not preferable because improvement in filtration efficiency remains high and pressure loss may increase.

The thickness of the trapping layer 14 can be measured in the following manner. First, the following six intersection points are determined from a section passing through the central axis in the extending direction of the cell 2 of the honeycomb filter 100 and parallel to the partition wall 1. The six intersection points are six intersections at which three straight lines that divide the above section into four equal parts in the extending direction of the cell 2 and two straight lines that divide the above section into three equal parts in the direction orthogonal to the extending direction of the cell 2 intersect. Then, with each intersection point as its center, a test piece including an area of 20 mm (vertical)×20 mm (horizontal) parallel to the above section is cut out. The thickness of the test piece (i.e., the depth parallel to the above section) can be arbitrarily determined. An arbitrary set of adjacent inflow cells 2a and outflow cells 2b is selected from the above test piece, and the average value of the surface height of each cell 2 (specifically, the surface height of each cell 2 in a direction perpendicular to the partition wall 1) is measured by a 3D profile measuring machine in a range of about 8 mm in the extending direction of the cell 2. Subsequently, the difference between the surface height of the inflow cell 2a and the surface height of the outflow cell 2b is calculated, and this is defined as the thickness of the trapping layer 14.

The average pore diameter of the partition wall 1 is preferably 7 to 19 μm, more preferably 7 to 12 μm, particularly preferably 7 to 9 μm. The average pore diameter of the partition wall 1 is a value measured by a mercury press-in method. The average pore diameter of the partition wall 1 can be measured, for example, using Autopore 9500 (trade name) manufactured by Micromeritics. If the average pore diameter of the partition wall 1 is less than 7 μm, it is not preferable because the transmission resistivity of the partition wall 1 is increased and pressure loss may increase. If the average pore diameter of the partition wall 1 is greater than 19 μm, it is not preferable from the viewpoint of moldability of the trapping layer 14 at the time of forming membrane.

The porosity of the partition wall 1 of the honeycomb structure 4 is preferably 48 to 65%, more preferably 55 to 60%, and particularly preferably 55 to 59%. The porosity of the partition wall 1 is measured by mercury press-in method. The porosity of the partition wall 1 can be measured using, for example, Autopore 9500 (trade name) manufactured by Micromeritics. If the porosity of the partition wall 1 is less than 48%, it is not preferable because the transmission resistivity of the partition wall 1 is increased and pressure loss is increased. If the porosity of the partition wall 1 is greater than 65%, it is not preferable because the strength may be significantly reduced.

In the honeycomb structure 4, the thickness of the partition wall 1 is preferably 0.152 to 0.305 mm, more preferably 0.190 to 0.267 mm, and particularly preferably 0.190 to 0.241 mm. The thickness of the partition wall 1 can be measured, for example, using Profile Projector. If the thickness of the partition wall 1 is less than 0.152 mm, enough strength may not be obtained. On the other hand, if the thickness of the partition wall 1 exceeds 0.305 mm, when the trapping layer 14 is disposed on the surface of the partition wall 1, pressure loss may be increased.

The shape of the cells 2 formed in the honeycomb structure 4 is not particularly limited. For example, the shape of the cells 2 in the section that is orthogonal to the extending direction of the cells 2 may be polygonal, circular, elliptical or the like. Examples of the polygonal shape include a triangle, a quadrangle, a pentagon, a hexagon, and an octagon. The shape of the cells 2 is preferably triangular, quadrangular, pentagonal, hexagonal or octagonal. Further, regarding the shape of the cells 2, all the cells 2 may have the same shape or different shapes. For example, although not shown, quadrangular cells and octagonal cells may be combined. Further, regarding the size of the cells 2, all the cells 2 may have the same size or different sizes. For example, although not shown, some of the plurality of cells may be larger, and other cells may be smaller relatively. In the present invention, the cell 2 refer to a space surrounded with a partition wall 1.

The cell density of the cell 2 defined and formed by the partition wall 1 is preferably 31 to 62 cells/cm², more preferably 31 to 55 cells/cm². With this configuration, it can be suitably used as a filter for trapping PM in exhaust gas emitted from vehicles.

The circumferential wall 3 of the honeycomb structure 4 may be integrally formed with the partition wall 1, or may be a circumferential coating layer formed by applying a circumferential coating material so as to surround the partition wall 1. Although not shown, the circumferential coating layer can be provided on the circumferential side of the partition wall after the partition wall and the circumferential wall are integrally formed and then the formed circumferential wall is removed by a known method, such as grinding, at the time of manufacturing.

The shape of the honeycomb structure 4 is not particularly limited. The honeycomb structure 4 may be a pillar-shape in which the shapes of the inflow end face 11 and the outflow end face 12 are circular, elliptical, polygonal, or the like.

The size of honeycomb structure 4, for example, the length of the honeycomb structure 4 in the extending direction of the cell 2 (hereinafter, also referred to as “total length”) and the size of the section perpendicular to the extending direction of the cell 2 of the honeycomb structure 4 (hereinafter, also referred to as “sectional area”) are not particularly limited. The respective sizes may be appropriately selected so as to obtain optimum purification performance when the honeycomb filter 100 is used. The total length of the honeycomb structure 4 is preferably 90 to 160 mm, and more preferably 120 to 140 mm. The sectional area of the honeycomb structure 4 is preferably 8000 to 16000 mm², and more preferably 10000 to 14000 mm².

The material of the partition wall 1 preferably contains at least one selected from the group consisting of cordierite, silicon carbide, silicon-silicon carbide composite material, mullite, alumina, aluminium titanate, silicon nitride, and silicon carbide-cordierite-based composite material. The material constituting the partition wall 1 is preferably a material containing 30% by mass or more of these materials listed in the above group, more preferably a material containing 40% by mass or more, and particularly preferably a material containing 50% by mass or more. In the honeycomb filter 100 of the present embodiment, as the material constituting the partition wall 1, cordierite is particularly preferable.

### (2) Manufacturing Method of Honeycomb filter

A method for manufacturing the honeycomb filter of the present invention is not particularly limited, and the honeycomb filter can be manufactured by the following method, for example.

First, a plastic kneaded material for making a partition wall of the honeycomb structure is prepared. The kneaded material for making a partition wall of the honeycomb structure can be prepared by adding additives such as a binder, a pore former, and water to a raw material powder for making above suitable materials of the partition wall. As the raw material powder, for example, powders of alumina, talc, kaolin, and silica can be used. Examples of the binder include methylcellulose and hydroxypropyl methylcellulose. Examples of the additives include surfactant.

Next, the kneaded material thus obtained is subjected to extrusion so as to make a pillar-shaped honeycomb formed body having a partition wall defining a plurality of cells and a circumferential wall disposed so as to encompass the partition wall. Next, the obtained honeycomb formed body is dried by microwaves and hot air, for example.

Next, a plugging portion is formed on the dried honeycomb formed body. The method for forming the plugging portion can be performed in accordance with a conventionally known method for manufacturing a honeycomb filter. For example, the inflow end face of the honeycomb formed body is first masked so that the inflow cells are covered. A plugging slurry is then rubbed into the end of the honeycomb formed body provided with a mask and an open end of the unmasked outflow cell is filled with the plugging slurry. Thereafter, for the outflow end face of the honeycomb formed body, an open end of the inflow cell is filled with the plugging slurry in the same manner as described above. The honeycomb formed body on which the plugging portion was formed is then further dried in a hot air dryer.

Next, the honeycomb formed body on which the plugging portion was formed is fired to make a honeycomb filter precursor prior to a trapping layer being disposed. When the honeycomb formed body is fired, the firing temperature and the firing atmosphere differ depending on raw materials for making a honeycomb formed body, and a person skilled in the art can select an optimum firing temperature and firing atmosphere for the selected materials.

Next, non-oxide particles for making a trapping layer are prepared. Then, the prepared non-oxide particles are caused to flow into the cells of the honeycomb filter precursor to adhere the non-oxide particles to the surface of the partition wall of the honeycomb filter precursor. A method of allowing the non-oxide particles to flow into the cells of the honeycomb filter precursor is not particularly limited, but a method of dispersing the non-oxide particles in a gas to form an aerosol and allowing the aerosol to flow into the cells can be exemplified. As the non-oxide particles, for example, silicon carbide particles can be exemplified as a preferable example. The average particle diameter of the silicon carbide particles is not particularly limited, but for example, the average particle diameter is preferably 0.4 to 2.4 μm.

As described above, after forming membrane by adhering non-oxide particles on the inner surface side of the partition wall surrounding the inflow cell of the honeycomb filter precursor, the non-oxide particles after forming membrane are oxidized (heat treated) at 600° C. or higher in an air atmosphere to bond the non-oxide particles to each other. By configuring in this way, the site that bonds non-oxide particles to each other becomes an oxide, and a trapping layer formed of a porous layer in which a plurality of non-oxide particles are bonded via the oxide is formed on the inner surface side of the partition wall surrounding the inflow cell of the honeycomb filter precursor. For example, when a membrane made of silicon carbide particles is used, a site that bonds silicon carbide particles to each other becomes silicon oxide (SiO₂), and a trapping layer made of a porous layer in which a plurality of non-oxide particles are bonded via an oxide can be easily produced. Although the temperature and time of oxidation (heat treatment) of non-oxide particles after forming membrane are not particularly limited, it is preferable to continue oxidation until the thickness of the site (silica oxide) that bonds silica particles to each other is 0.077 μm or more and the relational expression (1) described above is satisfied. For example, the oxidation temperature is preferably 800 to 1400° C., and the oxidation time is preferably 1 to 4 hours. The oxidation temperature and the oxidation time are heat treatment conditions that affect the thickness of the oxide that bonds non-oxide particles to each other. However, if either one of the oxidation temperature and the oxidation time satisfies the above numerical range, the thickness of the oxide is not necessarily equal to or greater than a certain value. It is preferable to appropriately select a heat treatment condition in which the thickness of the oxide becomes equal to or greater than a certain value while adjusting the oxidation temperature and the oxidation time within the above numerical range. In addition, the amount of oxide produced can also be grasped from the mass increase before and after the oxidation (heat treatment). For example, when silicon carbide particles are used as non-oxide particles, when the mass increase after the heat treatment is 20% or more relative to the mass of the raw material particles used, the thickness of silica oxide which is a bonding site is 0.077 μm or more and the relational expression (1) described above is satisfied. For example, although not particularly limited, when the average particle diameter R of the non-oxide particles is about 2.2 to 3.0 μm, the thickness of the silicon oxide can be 0.155 μm or more. The non-oxide particles after forming membrane can be oxidized by, for example, charging a honeycomb filter precursor into an electric furnace, or by heating the non-oxide particles adhered on the inner surface side of the partition wall with a gas burner. As described above, the honeycomb filter of the present invention can be manufactured.

### EXAMPLES

The following will describe in more detail the present invention by examples, but the present invention is not at all limited by these examples.

### Example 1

First, alumina, talc, kaolin, and silica raw material for making a partition wall of the honeycomb structure were prepared. To the prepared alumina, talc, kaolin, and silica raw material, 2 parts by mass of dispersing medium and 7 parts by mass of an organic binder were added, mixed, and kneaded to prepare a kneaded material. Water was used as the dispersing medium. Methylcellulose was used as the organic binder. Surfactant was used as the dispersing agent.

Next, the kneaded material was subjected to extrusion using a die for manufacturing of a honeycomb formed body to obtain a honeycomb formed body having a round pillar shape as the overall shape. The cells of the honeycomb formed body had a quadrangular shape.

Next, the honeycomb formed body was dried by a microwave dryer, and then was dried completely by a hot-air drier, and then both end faces of the honeycomb formed body were cut so as to have predetermined dimensions.

Next, a plugging portion was formed on the dried honeycomb formed body. Specifically, the inflow end face of the honeycomb formed body was first masked so that the inflow cells are covered. A plugging slurry was then rubbed into the end of the honeycomb formed body provided with a mask and an open end of the unmasked outflow cell was filled with the plugging slurry. After that, for the outflow end face of the honeycomb formed body, an open end of the inflow cell was filled with the plugging slurry in the same manner as described above. Then, the honeycomb formed body on which the plugging portion was formed was further dried in a hot air dryer.

The dried honeycomb formed body was then degreased and calcined to manufacture a honeycomb filter precursor prior to a trapping layer being disposed.

Next, a trapping layer was formed on the inner surface side of the partition wall surrounding the inflow cells of the honeycomb filter precursor in the following manner. Specifically, first, silicon carbide particles having an average particle diameter (median diameter) of 2.4 μm were prepared. Next, the prepared silicon carbide particles were dispersed in a gas to form an aerosol, and the aerosol was allowed to flow into the inflow cells. In this way, a membrane of the silicon carbide particles was formed on the inner surface side of the partition wall surrounding the inflow cells. Specific conditions for forming membrane of the silicon carbide particles are as follows.

Aerosol generator: RBG2000 manufactured by PALAS
Rotary body: Rotary brush
Non-oxide particles contained in container: silicon carbide particles (SiC particles)
Median diameter (D50): 2.4 μm
D10: 1.1 μm
D90: 4.5 μm
(based on the cumulative particle size distribution based on volume as measured by the laser diffraction/scattering method)
   Mass of injected non-oxide particles: 6.0 g medium gas: compressed dry air (dew point 10° C. or less)

### Ambient gas: Air

Average flow rate of aerosol flowing into honeycomb filter precursor: 3 m/s
Laser diffraction type particle size distribution measurement device: Insitec Spray manufactured by MALVERN
Operating time: 20 seconds
Nozzle inner diameter of aerosol generator: diameter 8 mm
Distance from nozzle end of aerosol generator to inflow end face of honeycomb filter precursor: 1000 mm
Aerosol injection rate: 20 m/s

Next, the honeycomb filter precursor in which a membrane of silicon carbide particles is formed is charged into an electric furnace. Heat treatment was performed at 1200° C. in an atmospheric atmosphere. In the heat treatment, the keeping time at 1200° C. was 2.2 hours. By the heat treatment, a trapping layer in which silicon carbide particles are bonded to each other by silicon oxide was formed on the inner surface side of the partition wall surrounding the inflow cell. By the heat treatment described above, a part of the particles (silicon carbide particles) used as raw material of the trapping layer was oxidized, and the mass after the heat treatment was increased by 20% with respect to the mass of raw material used. The mass increase of 20% due to the heat treatment was a mass increase caused by oxidation proceeding from the surface side of the silicon carbide particles and the surface side of the silicon carbide particles and the site bonding the silicon carbide particles to each other being oxides (silicon oxides). As a result of measuring the thickness of the oxide at the site that bonds the silicon carbide particles to each other by the above-described method, the thickness of the oxide was 0.155 μm. Table 1 shows the results. The honeycomb filter manufactured as described above was a honeycomb filter of Example 1.

The honeycomb filter of Example 1 had a round pillar shape, where shapes of the inflow end face and the outflow end face were round. The honeycomb structure had the length in the extending direction of the cell of 120 mm. The diameter of the end face of the honeycomb filter was 132 mm. The porosity of the partition wall of the honeycomb structure was 60%. The average pore diameter of the partition wall was 12 μm. The porosity and the average pore diameter of the partition wall were measured using Autopore 9500 (trade name) manufactured by Micromeritics. Table 1 shows the results. The honeycomb structure constituting the honeycomb filter had a partition wall thickness of 0.216 mm and a cell density of 31 cells/cm².

TABLE 1

| | | Example | Comparative | Comparative | Example | Example | Example | Example | Comparative |
|---|---|---|---|---|---|---|---|---|---|
| | | 1 | Example 1 | Example 2 | 2 | 3 | 4 | 5 | Example 3 |
| Honeycomb | End face | 132 | | | | | | | |
| Structure | Diameter (mm) | | | | | | | | |
| | Length (mm) | 120 | | | | | | | |
| | End face Shape | Round | | | | | | | |
| | Average Pore | 12 | | | 12 | | 10 | | |
| | Diameter (μm) | | | | | | | | |
| | Porosity (%) | 60 | | | 59 | | 57 | | |
| Trapping layer | Membrane forming | 4.6 | | | 4.6 | | 4.6 | | |
| | amount of Raw | | | | | | | | |
| | material | | | | | | | | |
| | particles (g/L) | | | | | | | | |
| | Particle diameter | 2.4 | 2.6 | 3 | 2.8 | 2.6 | 2.8 | 2.6 | 2.6 |
| | (μm) of Raw | | | | | | | | |
| | material particles | | | | | | | | |
| | Heat treatment method | Electric furnace | | | Gas burner | | | | |
| | Heat treatment | 1200 | 1180 | 1180 | 1180 | 1180 | 1180 | 1180 | 1130 |
| | temperature (° C.) | | | | | | | | |
| | Heat treatment | 2.2 | 2 | 2 | 2.7 | 2.7 | 2.7 | 2.7 | 2.7 |
| | keeping time (hours) | | | | | | | | |
| | Mass increase (%) due | 20 | 15 | 14 | 21 | 22 | 21 | 22 | 13 |
| | to Heat treatment | | | | | | | | |
| | Thickness T(μm) | 0.155 | 0.131 | 0.124 | 0.165 | 0.167 | 0.163 | 0.167 | 0.117 |
| | of Oxide layer | | | | | | | | |
| Mass Decrease (%) after Peeling test | | <3 | <3 | 5 | <3 | <3 | <3 | <3 | 6 |
| Decrease in Filtration | | <2 | 3.7 | 3.8 | <2 | <2 | <2 | <2 | 4.0 |
| Efficiency (%) after Peeling | | | | | | | | | |
| Evaluation | Peeling test | OK | NG | NG | OK | OK | OK | OK | NG |

| | | Example | Example | Example | Example | Example |
|---|---|---|---|---|---|---|
| | | 6 | 7 | 8 | 9 | 10 |
| Honeycomb | End face | 103 | | | | Long axis 231 |
| Structure | Diameter (mm) | | | | | Short axis 106 |
| | Length (mm) | 139 | | | | 120 |
| | End face Shape | Round | | | | Elliptical |
| | Average Pore | 9 | | 12 | | 9 |
| | Diameter (μm) | | | | | |
| | Porosity (%) | 55 | | 59 | | 55 |
| Trapping layer | Membrane forming | 5.5 | 9.6 | 11 | | 2.7 |
| | amount of Raw | | | | | |
| | material | | | | | |
| | particles (g/L) | | | | | |
| | Particle diameter | 2.4 | 2.4 | 2.8 | 2.6 | 2.4 |
| | (μm) of Raw | | | | | |
| | material particles | | | | | |
| | Heat treatment method | Gas burner | | | | Electric |
| | Heat treatment | 1180 | 1180 | 1180 | 1180 | 1200 |
| | temperature (° C.) | | | | | |
| | Heat treatment | 2.7 | 2.7 | 2.7 | 2.7 | 2.2 |
| | keeping time (hours) | | | | | |
| | Mass increase (%) due | 20 | 25 | 21 | 21 | 20 |
| | to Heat treatment | | | | | |
| | Thickness T(μm) | 0.158 | 0.178 | 0.163 | 0.163 | 0.158 |
| | of Oxide layer | | | | | |
| Mass Decrease (%) after Peeling test | | <3 | <3 | <3 | <3 | <3 |
| Decrease in Filtration | | <2 | <2 | <2 | <2 | <2 |
| Efficiency (%) after Peeling | | | | | | |
| Evaluation | Peeling test | OK | OK | OK | OK | OK |

The honeycomb filter of Example 1 was subjected to a peeling test of the trapping layer in the following manner. Table 1 shows the result.

### Peeling Test (Peeling Test of Trapping Layer)

First, a honeycomb filter 100 to be tested was mounted on the sample mounting part 41 of the vibration testing machine 20 as shown in FIG. 7, and a peeling test was performed on the trapping layer. FIG. 7 is a schematic plan view for explaining the configuration of the vibration testing machine for carrying out a peeling test of the trapping layer. As illustrated in FIG. 7, the vibration testing machine 20 includes a burner part 21 and a vibration part 31. The burner part 21 includes a combustion chamber 24 in which a main burner 22 and a pilot burner 23 are disposed. The main burner 22 and the pilot burner 23 are burners that use liquefied petroleum gas (LPG) as fuel, and pilot air is supplied to the pilot burner 23 in addition to fuel. Combustion air for burning fuel and cooling air for cooling the honeycomb filter 100 to stop combustion are supplied to the combustion chamber 24. The vibration part 31 is disposed below the sample mounting part 41 on which the honeycomb filter 100 is mounted, and applies vertical vibration to the sample mounting part 41. The sample mounting part 41 is configured such that the air heated by the burner part 21 flows while vibrating the honeycomb filter 100 mounted therein from the vibration part 31. In the peeling test, in the vibration part 31, the honeycomb filter 100 was subjected to a cycling test in which heated air heated by a burner and cooling air for cooling were alternately and repeatedly flowed under the following conditions while the vibrations of the frequency of 150 Hz and the gravitational acceleration of 40 g were applied. The heated air had an inflow temperature to flow into the honeycomb filter 100 of 900° C., and a flow rate of 2.0 Nm³/min. After the heated air is flowed for 5 minutes, the combustion of the main burner 22 and the pilot burner 23 is stopped, and the cooling air is flowed for 5 minutes. The peeling test was carried out by alternately flowing the heated air and the cooled air 75 times in this manner. After the peeling test, the honeycomb filter 100 was taken out from the sample mounting part 41, and the mass of the honeycomb filter 100 before and after the test (mass decrease) was measured. If the mass decrease after the test is less than 3% of the mass of the trapping layer and the decrease in filtration efficiency after the test is less than the measurement variation (2σ) calculated from the results of measurement obtained by repeating the measurement 30 times or more with the honeycomb filter prior to the test under the measurement conditions, it is considered to pass. Such passes are marked as “OK” in Table 1. On the other hand, if the mass decrease after the test is 3% or more of the mass of the trapping layer and the decrease in filtration efficiency after the test is equal to or greater than the measurement variation (2σ) calculated from the results of measurement obtained by repeating the measurement 30 times or more with the honeycomb filter prior to the test under the measurement conditions, it is considered a failure. Such failures are marked as “NG” in Table 1.

### Examples 2 to 13, Comparative Examples 1 to 3

The honeycomb filters of Examples 2 to 13 and Comparative Examples 1 to 3 were manufactured by changing the configuration of the honeycomb structure and the configuration of the trapping layers and the preparation methods thereof as shown in Tables 1 and 2. In Examples 2 to 5 and Comparative Example 3, the trapping layer was heat treated by a process in which a honeycomb filter precursor in which a membrane of silicon carbide particles was formed was heated using a gas burner. The honeycomb filters of Examples 2 to 13 and Comparative Examples 1 to 3 were also subjected to a peeling test of the trapping layer in the same manner as in Example 1. The results are shown in Tables 1 and 2. Note that Examples 1 to 13 satisfy the relational expression (1): R≤1.0609e\hat{ } (4.7057×T) described so far. On the other hand, Comparative Examples 1 to 3 do not satisfy the relational expression (1) described above.

TABLE 2

| | | Example 11 | Example 12 | Example 13 |
|---|---|---|---|---|
| Honeycomb | End face Diameter (mm) | 103 | | |
| Structure | Length (mm) | 139 | | |
| | End face Shape | Round | | |
| | Average Pore Diameter (μm) | 7 | | |
| | Porosity (%) | 59 | | |
| Trapping | Membrane forming amount of | 18 | | |
| layer | Raw material particles (g/L) | | | |
| | Particle diameter (μm) of | 0.9 | | |
| | Raw material particles | | | |
| | Heat treatment method | Electric furnace | | |
| | Heat treatment temperature | 1100 | 1130 | 1180 |
| | (° C.) | | | |
| | Heat treatment keeping time | 2 | 2 | 2 |
| | (hours) | | | |
| | Mass increase (%) due to | 20 | 25 | 30 |
| | Heat treatment | | | |
| | Thickness T(μm) of Oxide | 0.077 | 0.167 | 0.3 |
| | layer | | | |
| Mass Decrease (%) after Peeling test | | <3 | <3 | <3 |
| Decrease in Filtration Efficiency | | <2 | <2 | <2 |
| (%) after Peeling Test | | | | |
| Evaluation | Peeling test | OK | OK | OK |

### Results

The honeycomb filters of Examples 1 to 13 had a thickness T of the oxide of 0.077 μm or more and satisfied the above relational expression (1), and in the peeling test of the trapping layer, the peeling of trapping layer was not confirmed, resulting in OK (passing). On the other hand, the honeycomb filters of Comparative Examples 1 to 3 did not satisfy the relational expression (1): R≤1.0609e\hat{ } (4.7057×T) even when the thickness T of the oxide was 0.077 μm or more, and peeling of the trapping layer was confirmed in the peeling test of the trapping layer.

### INDUSTRIAL APPLICABILITY

The honeycomb filter of the present invention can be used as a filter to trap particulate matter in exhaust gas.

### Reference Signs List

1: partition wall, 2: cell, 2a: inflow cell, 2b: outflow cell, 3: circumferential wall, 4: honeycomb structure, 5: plugging portion, 7: pore, 11: inflow end face, 12: outflow end face, 14: trapping layer, 155: non-oxide particles, 16: oxide, 20: vibration testing machine, 21: burner part, 22: main burner, 23: pilot burner, 24: combustion chamber, 31: vibration part, 41: sample mounting part, and 100: honeycomb filter.

1. A honeycomb filter comprising: a honeycomb structure having a porous partition wall disposed to surround a plurality of cells which serve as fluid through channels extending from an inflow end face to an outflow end face; and
a plugging portion provided to seal either one end on the inflow end face side or the outflow end face side of the cells, wherein
the cells having the plugging portion at ends on the outflow end face side and that are open on the inflow end face side are inflow cells,
the cells having the plugging portion at ends on the inflow end face side and that are open on the outflow end face side are outflow cells,
the honeycomb structure further comprises a trapping layer for trapping particulate matter in exhaust gas on the inner surface of the partition wall surrounding the inflow cells,
the trapping layer is a porous layer in which a plurality of non-oxide particles are bonded via an oxide, a thickness of the oxide that bonds adjacent non-oxide particles is 0.077 μm or more, and when an average particle diameter of the non-oxide particles constituting the trapping layer is R(μm) and a thickness of the oxide is T(μm), a relation of R≤1.0609e\hat{ } (4.7057×T) is satisfied.

2. The honeycomb filter according to claim 1, wherein the oxide constituting the trapping layer is disposed so as to cover the surface of the non-oxide particles.

3. The honeycomb filter according to claim 1, wherein the non-oxide particles are silicon carbide particles.
